(19) United States
(12) Patent Application Publication
(10) Pub. No.: US 2009/0324250 A1
(43) Pub. Date: Dec. 31, 2009

(54) Wireless transmitters

(76) Inventors: Young-Kai Chen, Berkeley Heights, NJ (US); Vincent Etienne Houtsma, New Providence, NJ (US); Ting-Chen Hu, Edison, NJ (US); Nils Guenter Weimann, Gillette, NJ (US)

Correspondence Address: Alcatel-Lucent USA Inc.;Docket Administrator - Room 2F-192, 600 Mountain Avenue, Murray Hill, NJ, 07974-0636, US

(21) Appl. No.: 12/317,090

(22) Filed: Dec. 19, 2008

Related U.S. Application Data
(60) Provisional application No. 61/133,644, filed on Jun. 30, 2008.

(51) Int. Cl. H04B 10/04

(52) U.S. Cl. 398/182

(57) ABSTRACT

A wireless transmitter includes an optical modulator, an optical power splitter, a plurality of electrical drivers, and a plurality of antennas. The optical power splitter has a plurality of optical outputs and has an optical input connected to receive a modulated optical carrier from the optical modulator. Each driver is configured to detect a portion of the modulated optical carrier output by one of the optical outputs of the optical power splitter. Each antenna is connected to be driven by one of the electrical drivers.

This application claims the benefit of provisional application No. 61/133,644 filed Jun. 30, 2008 by Young-Kai Chen, Vincent Houtsma, Ting-Chen Hu, and Nils Weimann.

### BACKGROUND

1. Field of the Invention

The invention relates generally to data modulators and wireless transmitter and to methods of fabricating and using such devices.

2. Discussion of the Related Art

At high operating frequencies, electronic circuits have high losses due to internal capacitances and resistances. These internal capacitances and resistances can put upper bounds on obtainable frequencies for modulating electrical carriers.

### SUMMARY

Various embodiments include optical components for modulating data onto an optical carrier and electronic components for converting such a modulated optical carrier into a modulated electrical carrier to drive one or more antennas of a wireless transmitter. Such a division between optical-based modulation and electrical driving can aid to reduce power losses in wireless transmitters that operate at high frequencies.

One embodiment features a wireless transmitter that includes an optical modulator, an optical power splitter, a plurality of electrical drivers, and a plurality of antennas. The optical power splitter has a plurality of optical outputs and has an optical input connected to receive a modulated optical carrier from the optical modulator. Each driver is configured to detect a portion of the modulated optical carrier output by one of the optical outputs of the optical power splitter. Each antenna is connected to be driven by one of the electrical drivers.

In some embodiments of the wireless transmitter, each electrical driver includes a bipolar photo-transistor connected to detect the portion of the modulated optical carrier received from one of the outputs of the optical power splitter. Each bipolar photo-transistor may be connected to drive a corresponding one of the antennas with an electrical output signal therefrom.

In some embodiments, the wireless transmitter includes a light source connected to an optical input of the optical modulator. The light source is configured to produce an optical beam that is amplitude modulated with a regular subcarrier.

In some embodiments of the wireless transmitter, the optical power splitter, electrical drivers and antennae are integrated onto and/or into a single semiconductor substrate. In some such embodiments, each antenna is a patch antenna that is located along a surface of the semiconductor substrate.

In some embodiments, the wireless transmitter further includes an electrical controller configured to operate the antennas as a re-orientable phased-antenna array. In some such embodiments, the transmitter includes an optical amplifier between the optical modulator and the optical power splitter. In some other such embodiments, the transmitter includes a plurality of optical amplifiers, wherein individual ones of the optical amplifiers are configured to receive light from the optical power splitter and transmit amplified light to corresponding ones of the electrical drivers.

Another embodiment features a method of transmitting data, e.g., digital data. The method includes sequentially modulating the data onto a source optical beam, optically power splitting the modulated optical beam among a plurality of modulated optical sub-beams, and transmitting each modulated optical sub-beam to an electrical driver. Each electrical driver drives a corresponding antenna in a manner responsive to the modulated optical sub-beam received by the corresponding electrical driver.

In some embodiments of the method, the transmitting includes transmitting each received modulated optical sub-beam to a base of a corresponding bipolar transistor connected to drive a corresponding one of the antennas.

In some embodiments, the method further includes optically amplifying the modulated optical beam from the optical modulator.

In some embodiments, the method further includes optically amplifying the modulated optical sub-beams.

In some embodiments, the method further includes providing the source optical beam with a regular subcarrier modulated thereon. The modulating may include modulating the regular subcarrier in a manner responsive to the data, e.g., via phase modulation of the sub-carrier or amplitude modulation of the sub-carrier.

### BRIEF DESCRIPTION OF THE FIGURES

FIGS. 1A-1C are block diagrams schematically illustrating embodiments of wireless transmitters;

FIG. 2 is a flow chart illustrating a method of wireless transmission of data, e.g., using any of the wireless transmitters of FIGS. 1A-1C;

FIG. 3 is a cross-sectional view schematically illustrating embodiments of the wireless transmitters in FIGS. 1A-1C that are formed as integrated circuits (ICs); and

FIG. 4 is a schematic cross-sectional view of an IC with one or more semiconductor optical amplifiers integrated therein, e.g., in a wireless transmitter of FIGS. 1B-1C produced according to the method of FIG. 3.

In the Figures, similar reference numbers refer to features with substantially similar functions and/or structures.

In some of the Figures, relative dimensions of some features may be exaggerated to more clearly illustrate the structures shown therein.

While the Figures and the Detailed Description of Illustrative Embodiments describe some embodiments, the inventions may have other forms and are not limited to those described in the Figures and the Detailed Description of Illustrative Embodiments.

### DETAILED DESCRIPTION OF ILLUSTRATIVE EMBODIMENTS

U.S. provisional application No. 61/133,644, which was filed on Jun. 30, 2008, is incorporated herein my reference in its entirety.

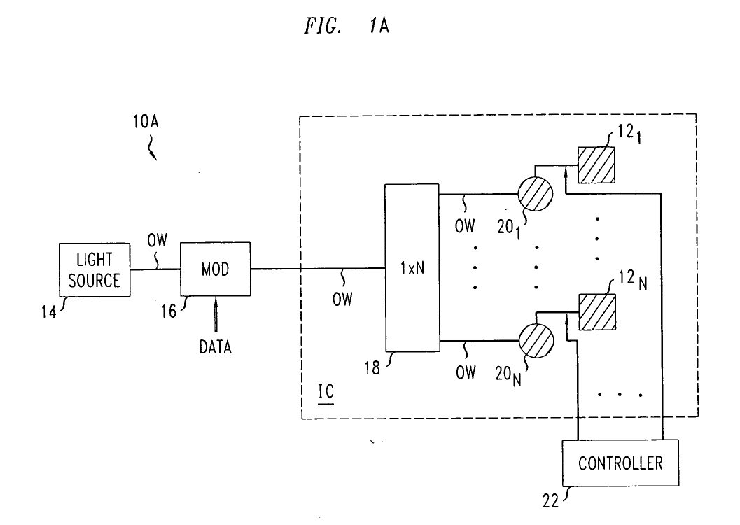

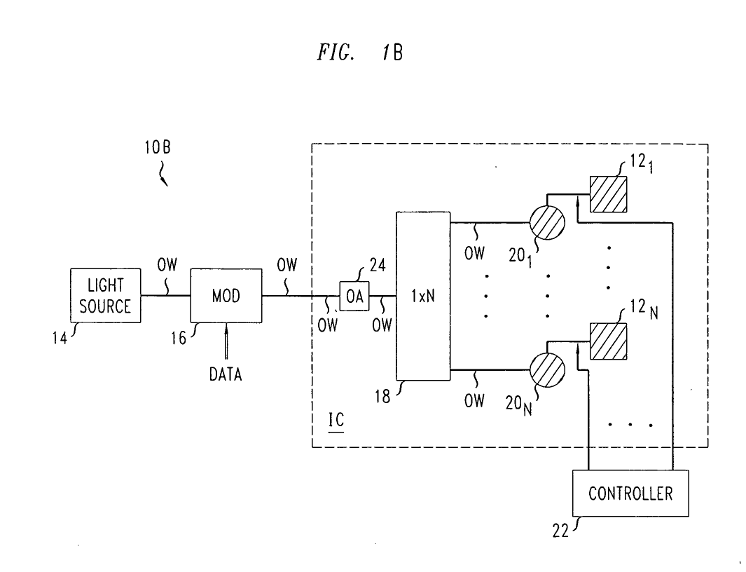

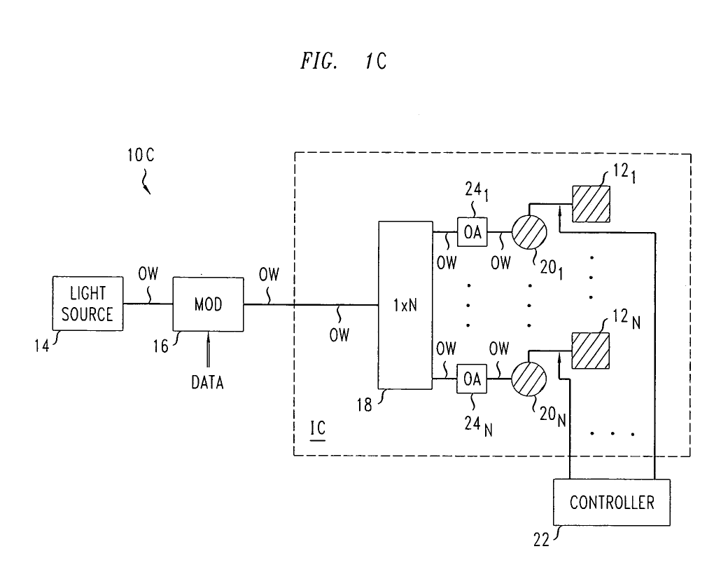

FIGS. 1A-1C illustrate wireless transmitters 10A-1B that may or may not be fabricated as integrated devices, i.e., as planar integrated circuits (ICs). The wireless transmitters 10A-1C optically and sequentially modulate a received analog or digital data onto an optical carrier and sequentially electrically detect the modulated optical carrier to produce a stream of electrical driving signals for the antennas 12₁ . . . 12_{N}. The antennas 12₁ . . . 12_{N} form an array having N>1 transmitting antenna elements, e.g., substantially identical transmitting elements.

Each wireless transmitter 10A-10C includes a light source 14, an optical modulator (MOD) 16, a 1×N optical power splitter 18, N photo-electrical drivers 20₁ . . . 20_{N}, and the N antennas 12₁ . . . 12_{N} of the array. In some embodiments, the wireless transmitters 10A-10C also include an electronic controller 22 of the array.

Referring to FIGS. 1B-1C, the specific wireless transmitters 10B, 10C include optical amplifiers (OA) 24, 24₁ . . . 24_{N}, e.g., conventional semiconductor optical amplifiers or erbium doped fiber amplifiers. In the wireless transmitter 10B, the optical amplifier 24, is located along the optical waveguide (OW) leading to the optical input of the 1×N optical power splitter 18. In the wireless transmitter 10C, the N optical amplifiers 24₁ . . . 24_{N} are located along the optical waveguides (OW) leading away from the N optical outputs the 1×N optical power splitter 18.

In various embodiments, the active and passive components of the wireless transmitters 10A-10C may or may not be integrated into and/or onto a single IC. Indeed, the optical modulator 16 may or may not also be integrated into an IC with the 1×N optical power splitter 18, photo-electrical drivers 20₁ . . . 20_{N}, and the antennas 12₁ . . . 12_{N} (not shown). Also, the light source 14 may not be integrated in the same IC (as shown) or may be integrated into the same IC (not shown).

The light source 14 may be, e.g., a coherent light source, e.g., a continuous wave (CW) laser. In some embodiments, the light source 14 produces an amplitude-modulated optical carrier, e.g., modulated with a regular sub-carrier of a single frequency. Such amplitude-modulation may be produced interfering, e.g., by beating together, CW light beams from two CW lasers having close optical output frequencies.

The optical modulator 16 may be any conventional optical modulator configured to sequentially modulate sequentially received data, e.g., digital or analog data, onto the optical beam received from the light source 14. The optical modulator 16 may include, e.g., a Mach-Zehnder interferometer with electrically-controllable phase delay(s) on one or both of its internal optical arms, i.e., phase delays (s) used to modulate the data onto the optical beam(s)/carrier(s) therein. Alternately, the optical modulator 16 may include a single optical waveguide whose optical path length is electrically controlled by the data in a stream of sequentially received digital data. The optical modulator 16 may also amplitude and/or phase modulate received analog or digital data onto a regular sub-carrier that is already modulated onto the optical beam in the light source 14.

The 1×N optical power splitter 18 passively splits a modulated light beam received from the optical modulator 16 into N optical sub-beams that are directed to the corresponding N optical outputs of the optical power splitter 18. In some embodiments, different ones of the optical sub-beams have about the same intensity. The optical power splitter 18 may include, e.g, a convention optical star coupler that power splits the received modulated light beam into the sub-beams directed to the different outputs of the optical power splitter 18. The optical power splitter 18 may alternately include a conventional 1×N optical multi-mode interference coupler that interferes different propagating optical modes produced by the received modulated optical beam to power split said modulated optical beam between different ones of the optical outputs of the 1×N optical power splitter 18.

Each photo-electrical driver 20₁ . . . 20_{N} outputs an electrical driving signal whose temporal current or voltage modulation is responsive to the temporal modulation on the optical sub-beam received therein. In embodiments where the light source 14 outputs a light beam modulated by a regular subcarrier, the time-dependent voltage or current of the electrical driving signals may be, e.g., fixed by the temporal modulation of the regular optical subcarrier of the optical sub-beams received in the photo-electrical drivers 20₁ . . . 20_{N}. Each electrical driving signal output by one of the photo-electrical drivers 20₁ . . . 20_{N} drives a corresponding one of the transmission antennas 12₁ . . . 12_{N}.

In some embodiments, each photo-electrical driver 20₁ . . . 20_{N} includes a photo-transistor or a photo-diode that is able to produce a current or voltage signal in response to absorbing light. In embodiments where the photo-electrical drivers 20₁ . . . 20_{N} are photo-transistors, the photo-transistors may be bipolar transistors configured to absorb light of the received optical sub-beam in their base layers so that the absorbed light photo-excites base currents. For example, each bipolar transistor may be a heterostructure transistor in which evanescent light from the received optical sub-beam only substantially excites charge carriers in its base layer. In particular, the base layer of the transistor may be formed of a semiconductor alloy whose bandgap is smaller than the energy of a single photon of the received optical sub-beams so that said optical sub-beam excites charge carriers in the base layer. In contrast, the emitter and collector layers may be formed of one or more semiconductor alloys with band gaps larger than the energy of a single photon of the received optical sub-beams so that said optical sub-beams do not substantially excite charge carriers in the emitter and collector layers. Thus, the optical sub-beams will generate base currents that such bipolar transistors can amplify to produce the voltage or current driving signals for driving the antennas 12₁ . . . 12_{N}.

The array of antennas 12₁ . . . 12_{N} may be located along a surface of an integrated circuit (IC), e.g., may be a directional array of conventional patch antennas for transmitting a wireless signal, e.g., a radio frequency signal. In some embodiments of the wireless transmitters 10A-10C, the transmission direction of such an array is controlled via an optional on-chip or off-chip electronic controller 22. The electronic controller 22 may, e.g., adjust and/or set relative phase delays between the electromagnetic waves emitted by different ones of the antennas 12₁ . . . 12_{N} thereby adjusting and/or setting the spatial antenna array's transmission direction for electromagnetic waves. That is, the electronic controller 22 may operate the array as a phased array in which relative phase-delays between the different antennas 12₁ . . . 12_{N} determine the transmission direction of the array in the far field.

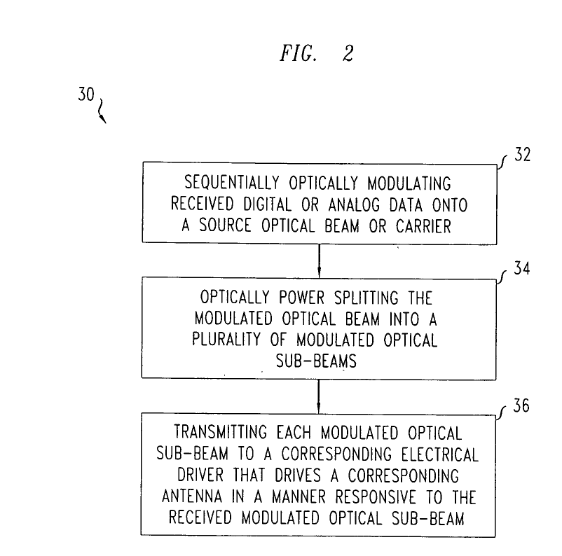

FIG. 2 illustrates a method 30 for wireless transmission of data over free space, e.g., in a point-to-point configuration. The method 30 may be use, e.g., to operate any of the wireless transmitters 10A-1C illustrated in FIGS. 1A-1C.

The method 30 includes sequentially optically modulating sequentially received digital or analog data onto a source optical beam or carrier, e.g., in optical modulator 16 of FIGS. 1A-1C (step 32). The source optical beam may be, e.g., a CW laser beam having a regular optical sub-carrier amplitude modulation thereon. In embodiments using such source optical beams, the received data may be phase and/or amplitude modulated onto the optical sub-carrier at the step 32. Such an optical sub-carrier may be produced, e.g., by interfering the light from two CW lasers having close output frequencies so that the optical sub-carrier frequency is the difference between the two output frequencies.

The method 30 includes passively optically splitting the modulated optical beam of the step 32 into a plurality of modulated optical sub-beams e.g., in the optical power splitter 18 of FIGS. 1A-1C (step 34). The passive optical splitting step 34 involves power splitting of the modulated optical beam into the optical sub-beams that carry the data modulation therein.

Herein, passive optical splitting refers to optical splitting done in an all-optical device without optical-to-electrical-to-optical conversions.

Herein, optical power splitting involves separating an input optical beam into a plurality of optical sub-beams, wherein the individual optical sub-beams have large intensities in substantially overlapping wavelength ranges or in substantially the same wavelength ranges. For example, optical WDM demultiplexers do not typically perform optical power splitting, but optical star couplers typically do perform optical power splitting.

The optical splitting step 34 may include optically amplifying the modulated optical beam prior to passively power splitting said modulated optical beam, e.g., in the optical amplifier 24 of FIG. 10B.

The optical splitting step 34 may include optically amplifying the individual modulated optical sub-beams produced by the passive splitting of said modulated optical beam, e.g., in the optical amplifiers 24₁ . . . 24_{N} of FIG. 10C.

The method 30 includes optically transmitting each individual modulated optical sub-beam to a corresponding electrical driver, e.g., the photo-electrical drivers 20₁ . . . 20_{N} in FIGS. 1A-1C (step 36). The transmitting step 36 may be performed by the optical waveguides (OW) connecting the N optical outputs of the 1×N optical power splitter 18 to corresponding ones of the photo-electrical drivers 20₁ . . . 20_{N} in FIGS. 1A-1C. In response to receiving a modulated optical sub-beam, each electrical driver produces an electrical driving signal whose temporal voltage or current modulations correspond to the temporal modulation of the received optical sub-beam. Each electrical driver also electrically drives a corresponding one of the antennas, e.g., the antennas 12₁ . . . 12_{N} in FIGS. 1A-1C, with the produced electrical driving signal. Thus, each produce electrical driving signal is modulated in a manner that is temporally responsive to the data modulation of the optical sub-beam received by the producing electrical driver, e.g., a modulation of the electrical driving signal may temporally correspond to the data modulation of a regular subcarrier modulated onto the received modulated optical sub-beam.

In some embodiments, the step 36 includes applying fixed relative phase delays to the electrical driving signals from different ones of the electrical drivers so the wireless signals, e.g., radio frequency signals, generated by the different antennas of the array will have fixed relative phase delays there between. The fixed relative phase delays may be set, e.g., by the electronic controller 22 of FIGS. 1A-1C, to cause the power of the wireless signal transmitted from the array to be substantially directed in a desired direction, e.g., to provide for point-to-point wireless transmission.

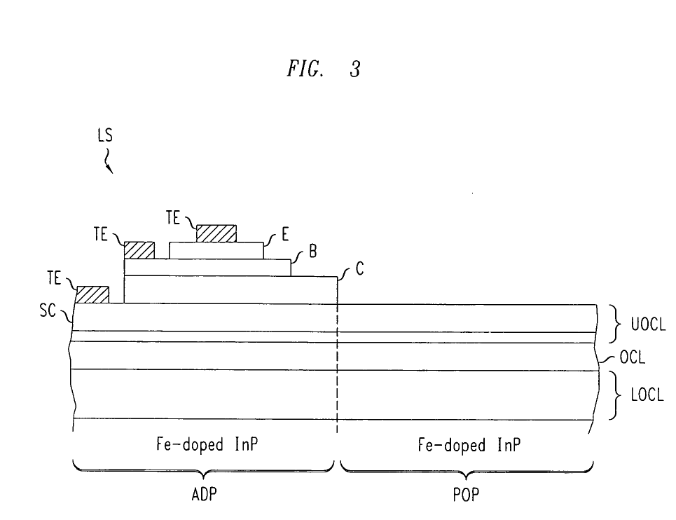

FIG. 3 illustrates one example of a layer structure 40 for some IC embodiments of the wireless transmitters 10A-10C of FIGS. 1A-1C. The layer structure includes an a lateral active driver portion (ADP) having the bipolar photo-transistors 20₁ . . . 20_{N} and a lateral passive optical portion (POP) having the optical waveguides (OW) and 10 the 1×N optical power splitter 18. The POP and ADP may also be covered by one or more top layers of a conventional dielectric (not shown), which protect and/or planarize the surface of the IC.

Parts of the passive optical portion (POP) may optionally include one or more of the semiconductor optical amplifier(s) 24, 24₁, . . . 24_{N} as shown in FIG. 5.

The POP and ADP are located over a planar surface of a crystalline indium phosphide (InP) substrate, e.g., a (100) lattice plane. The InP is iron (Fe) doped by conventional techniques to be an electrically semi-insulating substrate.

In the POP, the optical waveguide includes crystalline semiconductor optical core and cladding layers. The optical core layer (OCL) is laterally patterned to form the optical waveguides (OW) and other passive optical structures, e.g., the 1×N optical power splitter 18 of FIG. 1. The optical core layer includes semiconductor alloy(s) having higher refractive indexes than adjacent optical cladding layers, e.g., one or more InGaAlAs alloys. The lower optical cladding layer (LOCL) may be formed by the Fe-doped InP substrate alone or may include other layer(s), e.g., doped and/or undoped InP layer(s) located on the Fe-doped InP substrate. The upper optical cladding layer (UOCL) may be formed by of one or more layers of doped and/or undoped InP.

In the ADP, the bottom-to-top layer structure is the optical core layer, one or more upper optical cladding layers, and the layers of the bipolar photo-transistors 20₁ . . . 20_{N} located thereon. The bipolar photo-transistors 20₁ . . . 20_{N} are located on a surface of the optical waveguide to enable evanescent optical fields from the optical waveguide (OW) to couple to the bipolar photo-transistors 20₁ . . . 20_{N}.

Each bipolar photo-transistor 20₁ . . . 20_{N} has crystalline semiconductor layers for a collector (C), a base (B), an emitter (E), and a sub-collector (SC) and also has various top electrodes (TEs). The collector, base, and emitter layers form the functional electronic layers of the bipolar photo-transistor. The sub-collector layer is a heavily doped semiconductor layer that is a bottom electrode for the collector layer and an optical window for the underlying portion of the optical waveguide (OW). The set of top electrodes are metal or heavily doped semiconductor layers that contact top portions of the sub-collector, base and emitter layers, i.e., to form electrodes therefore.

In an embodiment of the layer structure 40, in which the bipolar photo-transistors 20₁ . . . 20_{N} are NPN bipolar transistors, individual ones of the semiconductor layers, e.g., layers of the optical waveguide OW and the SC, C, B, and E layers, may have the exemplary thicknesses and compositions described below.

In the optical waveguide, the optical core layer (OCL) and the upper optical cladding layers (UOPL) are transparent to light in the optical communications C-band. The optical communications C-band includes the output wavelength of the light source 14 of FIGS. 1A-1C that is used for these example embodiments. For that reason, these layers of the optical waveguide are formed of semiconductor alloys whose bandgaps are too large to enable charge carrier excitation via absorption of single photons in the optical communications C-band. For example, these layers may include an InₓAl_{y}Ga_{(1-x-y)}As layer, e.g., an OCL, in which the x and y alloy parameters are about 0.53 and about 0.13, respectively and one or more InP layers. Below the bipolar photo-transistor, the upper optical cladding layers may have total thicknesses of 100 nm to 600 nm, e.g., about 200 nm, and may be undoped to provide for electrical isolation.

The sub-collector (SC) layer is an n-type semiconductor layer that is substantially transparent to light in the optical communications C-band. For example, the SC layer may be an n-type InP layer with a thickness of 100 nm to 500 nm, e.g., 250 nm, and with a dopant density of 3×e¹⁸ to 6×e¹⁹ silicon (Si) atoms per centimeter cubed (/cm³), e.g., about 4×e¹⁹ Si-atoms/cm³.

The collector (C) layer may be an n-type semiconductor layer with a substantially transparent bottom and top transition sublayers. The bottom sublayer may have a bandgap larger than a photon energy in the optical communications C-band. The top transition sublayer may be vertically graded so that its top portion has a smaller bandgap, e.g., so that single C-band photons can or cannot excite some charge carrier excitations therein. The bottom sublayer may be an n-type InₓAl_{y}Ga_{(1-x-y)}As layer with a thickness of 40 nm to 200 nm, e.g., about 120 nm, and alloy parameters x and y with respective values of about 0.53 and about 0.13. The top sublayer may be an In_{x′}Al_{y′}Ga_{(1-x′-y′)}As layer with a thickness of 5 nm to 30 nm, e.g., about 15 nm, and may have an x′ alloy parameter of about 0.53 and a y′ alloy parameter bottom-to-top graded from about 0.13 to about 0.0. The top and bottom sublayers may be both n-type doped to have between 10¹⁵ and 10¹⁸ Si-atoms/cm³, e.g., 10¹⁷ Si-atoms/cm³.

The base (B) layer is a thin p-type semiconductor layer that may have a very small bandgap, e.g., about 0.78-electron volts, so that absorptions of single photons from the light source 14 have energies sufficient to cause charge carrier excitations across the bandgap. The base layer may be, e.g., an InₓGa₍₁₋ₓ₎As layer with a thickness of about 20 nm to 100 nm, e.g., about 50 nm, and an alloy parameter x between 0.532 and 0.42. The base layer may be heavily p-type doped to have between about 10¹⁸ and 10²⁰ carbon atoms/cm³, e.g., 4×10¹⁹ carbon atoms/cm³.

The emitter layer may be an n-type doped semiconductor multilayer in which the bottom sublayer is similar to an upper optical cladding layer and the middle sublayer and emitter cap sublayers are heavily doped. The bottom sublayer may be an n-type InP layer in which the bottom 20 nm to 100 nm, e.g., 30 nm, is doped with 10¹⁷ to 10¹⁹ Si-atoms/cm³, e.g., 10¹⁸ Si-atoms/cm³, and the top 20 nm to 100 nm, e.g., 70 nm, is doped with 10¹⁸ to 3×10¹⁹ Si-atoms/cm³, e.g., 10¹⁹ Si-atoms/cm³. The middle sublayer may be an n-type InₓGa₍₁₋ₓ₎As layer with a thickness of 20 nm to 200 nm, e.g., 150 nm, an x alloy parameter of about 0.532 and a dopant density of 1×10¹⁹ to 6×10¹⁹ Si-atoms/cm³, e.g., 4×10¹⁹ Si-atoms/cm³. The emitter cap sublayer may be an n-type In_{x′}Ga_{(1-x′)}As layer with a thickness of 5 nm to 50 nm, e.g., 10 nm, an x′ alloy parameter of about 0.8 and an n-type dopant density about equal to that of the middle sublayer.

In some embodiments, the layer structure of the bipolar photo-transistor itself is inverted. Then, the bottom-to-top layer structure includes an emitter layer, a base layer, a collector layer, and a collector electrode layer, wherein the emitter layer rests on or over part of the optical waveguide (OW). In such embodiments, significant lateral regions of the collector electrode and/or collector layers may be etched away to lower parasitic capacitances in the bipolar photo-transistor.

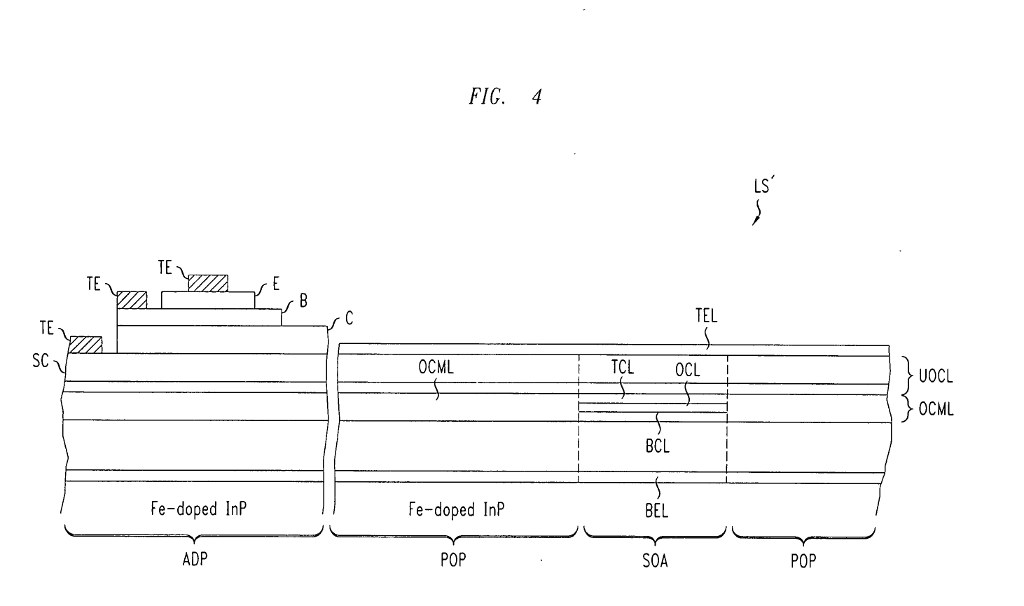

FIG. 4 illustrates an example layer structure LS′ of an embodiment of the wireless transmitters 10B-10C of FIGS. 1B-1C in which one or more semiconductor optical amplifiers, e.g., SOA 24 or SOAs 24₁ . . . 24_{N}, are integrated into the same IC as the 1×N optical power splitter 18 and the bipolar photo-transistors 20₁ . . . 20_{N}. An exemplary layer structure for such SOAs is a diode structure that is described below. The diode structure of the SOA(s) may be used, e.g., in an IC in which the bipolar photo-transistors 20₁ . . . 20_{N} have the previously described structure.

For such SOAs, the diode structure has a bottom electrode layer (BEL) of heavily n-type doped InP that is located on the semi-insulating InP substrate, e.g., a conventional Fe-doped InP substrate. For example, the bottom electrode layer may have a thickness of about 900 nm and a dopant concentration of about 10¹⁸ Si-atoms/cm³.

For such SOAs, the diode structure has a bottom n-type InP semiconductor layer that is located on the bottom electrode layer. The bottom n-type InP layer may have a thickness of about 200 nm and a dopant concentration of about 5×10¹⁷ Si-atoms/cm³.

For such SOAs, the diode structure has an optical core/cladding multilayer of not intentionally doped or intrinsic quaternary semiconductor alloys that is located on the bottom n-type InP layer. The optical core/cladding multilayer includes an about 190 nm thick top cladding layer (TCL) and an about 190 nm thick bottom cladding layer (BCL) of the same InₓGa_{y}Al_{(1-x-y)}As alloy. The alloy may be constructed to have a bandgap energy of a photon whose wavelength is near 1.25 μm. For example, the x alloy parameter may be about 0.53 and the y alloy parameter may be about 0.34. The optical core/cladding multilayer includes an about 120 nm thick optical core layer (OCL) of a different In_{x′}Ga_{y′}Al_{(1-x′-y′)}As alloy. The optical core layer OCL is able to amplify light at the 1.55 μm wavelength of the telecommunications C-band, e.g., via cross-bandgap de-excitations of charge carriers. For example, the optical core layer may have x′ and y′ alloy parameters selected to produce a bandgap energy equal to that of a photon whose wavelength is about 1.55 μm.

For such SOAs, the diode structure has p-type InP upper optical cladding layers that are located on the optical core/cladding multilayer. From bottom-to-top, these upper optical cladding layers may include about 200 nm of p-type InP doped with about 10¹⁷ carbon or beryllium (Be) atoms/cm³, about 300 nm of p-type InP doped with about 5×10¹⁷ carbon or beryllium atoms/cm³, and about 1000 nm of p-type InP doped with about 10¹⁸ carbon or beryllium atoms/cm³.

For such SOAs, the diode structure may have a top electrode layer (TEL) of p-type InGaAs that is located on the upper optical cladding layers. The top electrode layer may have a thickness of about 300 nm and may be doped with about 1.5×10¹⁹ carbon or beryllium atoms/cm³.

For such SOAs, the passive optical waveguides of the POP portion of the IC may have a layer structure similar to the layer structure of the SOA except that the optical core/cladding multilayer and upper optical cladding layers are modified as follows. The optical core/cladding multilayer is replaced by an optical core multilayer (OCML) formed by a 140 nm thick bottom InₓGa_{y}Al_{(1-x-y)}As layer and a 360 nm thick top InₓGa_{y}Al_{(1-x-y)}As layer. In both InₓGa_{y}Al_{(1-x-y)}As layers, the x and y alloy parameters are selected to produce bandgap energies near the energies of single photons with a wavelength of about 1.25 μm. For example, the x alloy parameter may be about 0.53 and the y alloy parameter may be about 0.34. Also, the lowest 200 nm of the upper optical cladding layers may also be p-type doped to about 6×10¹⁶ carbon or beryllium atoms/cm³ rather than to 10¹⁷ carbon or beryllium atoms/cm³ as in the corresponding layer of the SOA structure.

In FIGS. 3-4, the various structures can be made by conventional processes. For example, the semiconductor layers may be fabricated via conventional epitaxial deposition and doping processes. The resulting layer structures can then, be laterally patterned and etched by conventional processes to produce the various optical and electronic elements therein. In some embodiments, the ADP and POP of the IC are made first and lateral portions of the resulting IC structure are then, anisotropically etched to the Fe-doped InP substrate to provide an areas fabricating the SOA(s) thereon.

Other structures and manufacturing methods for SOAs and micro-electronics integration methods that may be useful for fabricating IC structures in some of the above-described embodiments may be described in one or more of the articles: “1.55 um Polarization-Insensitive Optical Amplifier with Strain-Balanced Superlattice Active Layer”, by A. Godefroy et al, IEEE PHOTONICS TECHNOLOGY LETTERS, VOL. 7, NO. 5 (May 1995), starting at page 473; “Monolithically Integrated Differential Mach-Zehnder Filter for 40 Gb/s Wavelength Conversion in High-Confinement Butt-Joint SOAs,” by P. Bernasconi et al, Indium Phosphide and Related Materials Conference Proceedings, 2006 International Conference on (7-11 May 2006) pages 241-243; and High-Performance InP-Based Photodetector in an Amplifier Layer Stack on Semi-Insulating Substrate”, by Ling Xu et al, IEEE Photonics Technology Letters, Vol. 20, No. 23 (1 Dec. 2008) pages 1941-1943. Both of the above-referenced articles are incorporated herein by reference in their entirety.

Structures and manufacturing methods for the photo-transistors and integration methods thereof, which may be useful in some embodiments, are described in U.S. patent application Ser. No. 11/180,122, filed Jul. 13, 2005 by Young-Kai Chen et al. This patent application is incorporated herein by reference in its entirety.

The invention is intended to include other embodiments that would be obvious to a person of ordinary skill in the art in light of the description, figures, and claims.

What is claimed is:

1. A wireless transmitter, comprising:
an optical modulator;
an optical power splitter having a plurality of optical outputs and having an optical input connected to receive a modulated optical carrier from the optical modulator;
a plurality of electrical drivers, each driver configured to detect a portion of the modulated optical carrier output by one of the optical outputs of the optical power splitter; and
a plurality of antennas, each antenna being connected to be driven by one of the electrical drivers.

2. The transmitter of claim 1, wherein each electrical driver includes a bipolar photo-transistor connected to detect the portion of the modulated optical carrier received from one of the outputs of the splitter.

3. The transmitter of claim 2, wherein each bipolar photo-transistor is connected to drive a corresponding one of the antennas with an electrical output signal therefrom.

4. The transmitter of claim 2, further comprising a light source connected to an optical input of the optical modulator, the light source being configured to produce an optical beam that is amplitude modulated with a regular subcarrier.

5. The transmitter of claim 1, wherein the optical power splitter, electrical drivers and antennas are integrated onto and/or into a single semiconductor substrate.

6. The transmitter of claim 5, wherein each antenna is a patch antenna located along a surface of the semiconductor substrate.

7. The transmitter of claim 1, further comprising an electrical controller configured to operate the antennas as a re-orientable phased-antenna array.

8. The transmitter of claim 7, further comprising an optical amplifier located between the modulator and the optical power splitter.

9. The transmitter of claim 7, further comprising a plurality of optical amplifiers, individual ones of the optical amplifiers are configured to receive light from the optical power splitter and transmit amplified light to corresponding ones of the electrical drivers.

10. A method of transmitting data, comprising:
sequentially modulating data onto a source optical beam;
optically power splitting the modulated optical beam into a plurality of modulated optical sub-beams;
transmitting each modulated optical sub-beam to a corresponding electrical driver such that the electrical driver drives a corresponding antenna in a manner responsive to the modulated optical sub-beam received by the corresponding electrical driver.

11. The method of claim 10, wherein the transmitting includes transmitting each modulated optical sub-beam to a base of a corresponding bipolar transistor connected to drive a corresponding one of the antennas.

12. The method of claim 10, further comprising optically amplifying the modulated optical beam from the optical modulator.

13. The method of claim 10, further comprising optically amplifying the modulated optical sub-beams.

14. The method of claim 10, further comprising providing the source optical beam with a regular subcarrier modulated thereon.

15. The method of claim 14, wherein the modulating includes modulating the regular subcarrier in a manner responsive to the data.

16. The method of claim 15, wherein the modulating includes phase modulating the regular subcarrier.

17. The method of claim 15, wherein the modulating includes amplitude modulating the regular subcarrier.

18. The method of claim 10, wherein the data is digital data.
